(19) United States
(12) Patent Application Publication
(10) Pub. No.: US 2025/0208926 A1
(43) Pub. Date: Jun. 26, 2025

(54) RESOURCE SELECTION

(71) Applicant: Arm Limited, Cambridge (GB)

(72) Inventors: Xiaoyang SHEN, Valbonne (FR); Shun WAN, Cambridge (GB); Zichao XIE, Cambourne (GB); Maria Teresa BEVIVINO, Nice (FR)

(21) Appl. No.: 18/393,865

(22) Filed: Dec. 22, 2023

(51) Int. Cl. G06F 9/52; G06F 9/30

(52) U.S. Cl. CPC G06F 9/52; G06F 9/30036

(57) ABSTRACT

Resource selection circuitry selects one or more selected resources from among a set of resources, based on availability information indicating whether each resource is available or unavailable for selection. The resource selection circuitry comprises unavailable resource counting circuitry to generate count values indicative of a number of unavailable resources indicated by respective portions of the availability information; shift circuitry to perform, depending on the count values, a plurality of shift stages on a resource identifier vector comprising a plurality of resource identifier elements each for representing a resource identifier of a corresponding one of the resources, to compact the resource identifier elements corresponding to available resources into a contiguous portion of the resource identifier vector; and selection circuitry to select, as the one or more selected resources, one or more resources corresponding to resource identifier elements indicated in said contiguous portion of the resource identifier vector.

### BACKGROUND

### Technical Field

The present technique relates to the field of data processing.

### Technical Background

There can be a number of scenarios in a data processing system where circuitry can be provided to select one or more available resources from among a set of resources, each of which is indicated as available or unavailable by corresponding availability information. If the number of resources available for selection is relatively large, a problem can arise where it can be challenging to provide circuitry that is fast enough to process the availability information to identify which resources are available (while meeting timing requirements imposed by the fast clock frequencies supported by modern processors).

### SUMMARY

At least some examples of the present technique provide resource selection circuitry to select one or more selected resources from among a set of resources, based on availability information indicating whether each resource is available or unavailable for selection; the resource selection circuitry comprising:
unavailable resource counting circuitry to generate count values indicative of a number of unavailable resources indicated by respective portions of the availability information;
shift circuitry to perform, depending on the count values, a plurality of shift stages on a resource identifier vector comprising a plurality of resource identifier elements each for representing a resource identifier of a corresponding one of the resources, to compact the resource identifier elements corresponding to available resources into a contiguous portion of the resource identifier vector; and
selection circuitry to select, as the one or more selected resources, one or more resources corresponding to resource identifier elements indicated in said contiguous portion of the resource identifier vector.

At least some examples of the present technique provide a processor comprising the resource selection circuitry described above.

At least some examples provide a system comprising:
the resource selection circuitry or the processor described above, implemented in at least one packaged chip;
at least one system component; and
a board,
wherein the at least one packaged chip and the at least one system component are assembled on the board.

At least some examples provide a chip-containing product comprising the system described above, assembled on a further board with at least one other product component.

At least some examples provide a non-transitory computer-readable medium to store computer-readable code for fabrication of resource selection circuitry to select one or more selected resources from among a set of resources, based on availability information indicating whether each resource is available or unavailable for selection; the resource selection circuitry comprising:
unavailable resource counting circuitry to generate count values indicative of a number of unavailable resources indicated by respective portions of the availability information;
shift circuitry to perform, depending on the count values, a plurality of shift stages on a resource identifier vector comprising a plurality of resource identifier elements each for representing a resource identifier of a corresponding one of the resources, to compact the resource identifier elements corresponding to available resources into a contiguous portion of the resource identifier vector; and
selection circuitry to select, as the one or more selected resources, one or more resources corresponding to resource identifier elements indicated in said contiguous portion of the resource identifier vector.

At least some examples provide a method for selecting one or more selected resources from among a set of resources, based on availability information indicating whether each resource is available or unavailable for selection; the method comprising:
using unavailable resource counting circuitry, generating count values indicative of a number of unavailable resources indicated by respective portions of the availability information;
using shift circuitry, performing, depending on the count values, a plurality of shift stages on a resource identifier vector comprising a plurality of resource identifier elements each for representing a resource identifier of a corresponding one of the resources, to compact the resource identifier elements corresponding to available resources into a contiguous portion of the resource identifier vector; and
using selection circuitry, selecting, as the one or more selected resources, one or more resources corresponding to resource identifier elements indicated in said contiguous portion of the resource identifier vector.

Further aspects, features and advantages of the present technique will be apparent from the following description of examples, which is to be read in conjunction with the accompanying drawings.

### BRIEF DESCRIPTION OF THE DRAWINGS

FIG. 1 illustrates an example of a processor having a number of instances of resource selection circuitry;

FIG. 2 illustrates an example of the resource selection circuitry;

FIG. 3 illustrates an example of unavailable resource counting circuitry;

FIG. 4 illustrates an example of shift circuitry;

FIG. 5 illustrates an example of shift circuitry and bit injection circuitry;

FIGS. 6 and 7 illustrate a worked example of using the resource selection circuitry to select available resources from a set of resources based on availability information;

FIG. 8 illustrates an example where a given shift stage includes a first shift and second shift based on first and second terms of a redundant representation of a count value;

FIG. 9 illustrates an example based on an asymmetric binary tree of shifters, to handle discontinuity in the identifiers of the set of resources available for selection;

FIG. 10 illustrates a method for resource selection; and

FIG. 11 illustrates a system and a chip-containing product.

### DESCRIPTION OF EXAMPLES

Resource selection circuitry is provided to select one or more selected resources from among a set of resources, based on availability information indicating whether each resource is available or unavailable for selection. For selecting a maximum of N available resources from the set of resources, one way of implementing the resource selection circuitry can be provide circuitry which sequentially checks each element of the availability information to identify whether the corresponding resource is available or unavailable, and halt the search once N available resources have been found. However, this sequential approach may be unacceptably slow in terms of meeting timing requirements. To speed up searching, some implementations split the availability information into segments and, for each segment, start the sequential search from both ends of each segment, to find a maximum of 2 available resources per segment of the availability information (one starting from the bottom end of the segment and another starting from the top end of the segment). However, while this enables faster searching for available resources by parallelizing the processing of each segment, it has the disadvantage that it is limited to returning a maximum of two available resources per segment, so if the available resources are not evenly distributed (e.g. with more than 2 available resources in one segment and no available resources in any other segment), the resource selection circuitry will be unable to find all of the N available resources desired, so may return a result indicating that fewer than N resources are available, even if there are actually N or more available resources. In other words, to achieve better timing, performance is sacrificed, because indicating there are fewer resources available than the actual number of available resources may impact on performance as it could mean that an operation which requires available resource may be blocked from proceeding when really it could have proceeded if the resource selection circuitry was better able to find all available resources.

In contrast, in the examples discussed below, the resource selection circuitry comprises unavailable resource counting circuitry to generate count values indicative of a number of unavailable resources indicated by respective portions of the availability information; shift circuitry to perform, depending on the count values, a plurality of shift stages on a resource identifier vector comprising a plurality of resource identifier elements each for representing a resource identifier of a corresponding one of the resources, to compact the resource identifier elements corresponding to available resources into a contiguous portion of the resource identifier vector; and selection circuitry to select, as the one or more selected resources, one or more resources corresponding to resource identifier elements indicated in said contiguous portion of the resource identifier vector.

Hence, the resource selection is based on a number of shift stages shifting the positions of resource identifier elements within a resource identifier vector, based on counts of the number of unavailable resources indicated by respective portions of the availability information. The shift stages compact the resource identifier elements which correspond to resources indicated as available into a contiguous portion of the resource identifier vector.

With this approach, the search for available resources can be relatively fast (or at least, the timing scales more slowly with the total number of resources) since a given shift stage implemented by the shift circuitry (other than the final shift stage) may act in parallel on two or more portions of the resource identifier vector corresponding to different subsets of resources. Since the shift circuitry shifts the resource identifier elements for available resources into a contiguous portion of the resource identifier vector, this avoids the problem discussed above where some available resources cannot be located due to a limitation of the selection algorithm implemented by the circuitry. For any possible distribution of N or more available resources throughout the set of resources, the shift circuitry is able to identify N available resources per resource selection cycle (where N is the maximum number of resources required to be selected in a given cycle). Another advantage of using this technique for resource selection can be that the selection circuitry can be simpler because the resource identifiers of up to N available resources can be read out from the contiguous portion of the resource identifier vector, rather than needing a more complex decoding operation to deduce a numeric value of an identifier of the available resource from a relative position within the availability information at which an indication of available resource was detected.

The shift circuitry may comprise a binary tree of shifters. A binary tree may be a structure where each node of the tree has a maximum of two parent nodes. Hence, a number of stages of shifters may be provided, each node in a given stage bringing together results of a maximum of two nodes of the preceding stage. A binary tree design can be an efficient structure for compacting the resource identifier elements of the available resources into the contiguous portion, as it enables some parallelization of the shifts performs within a given stage, and the binary scaling of the size of the portions processed in successive shift stages means that even if the total number of resources in the set is relatively large, the speed of searching can be fast enough to meet timing requirements in identifying a subset of available resources.

In some examples, for a given shift stage applied to one or more groups of resource identifier elements from the resource identifier vector, for each group the shift circuitry may shift resource identifier elements of a first portion of the group by a given number of element positions into a second portion of the given group. The given number corresponds to the number of unavailable resources indicated by a given count value generated by the unavailable resource counting circuitry based on a portion of the availability information corresponding to the second portion of the given group. This operation is helpful in causing the resource identifier elements corresponding to available resources to be shifted towards the contiguous portion of the resource identifier vector.

In some examples, the first portion may be a most significant portion of the group (comprising elements positioned at higher element index positions of the resource identifier vector) and the second portion may be a less significant portion of the group (comprising elements positioned at lower element index positions of the resource identifier vector). In this case, the contiguous portion may be the lowest N element index positions of the resource identifier vector following a final stage of shifting. Alternatively, other approaches could perform the shifts the other way round, so that the first portion is the least significant portion of the group and the second portion is the more significant portion of the group, and in this case the contiguous portion may be the higher N element index positions of the resource identifier vector following a final stage of shifting.

This operation can be implemented as a binary tree of shifts. For example, in each stage, for one or more groups of resource identifier elements processed in that stage, the second portion of the given group may comprise a number of resource identifier elements which is an exact power of 2. If the binary tree is a complete symmetric tree (where the total number of resources is an exact power of 2 with continuously ascending resource identifier numbers from 0 to 2^{Y}−1), the first portion may also comprise an exact power of 2 of equal number of resource identifier elements to the second portion (e.g. in that case the first/second portions may be, respectively, the upper and lower halves of the group or vice versa). However, in some implementations, the tree may become asymmetric, for a number of reasons, e.g.:
to deal with a set of resources that does not comprise an exact power-of-2 number of resources,
to deal with discontinuities in the series of resource identifier values used to identify the resources, or
to reflect that in later stages of the shift tree it may not be necessary to calculate all positions of the resource identifier vector as given the limitation in the maximum number of resources required to be selected per cycle, some positions of the resource identifier vector in later stages may not contribute to the end result.
   Hence, for some nodes of the tree, the shifts may be based on a first portion which has a smaller number of elements than the corresponding power-of-2 number of elements in the second portion.

The number of resource identifier elements in the second portion of each group may increase from one shift stage to the next shift stage. More particularly, with a binary tree approach, the number of resource identifier elements in the second portion may double from one shift stage to the next shift stage.

In some implementations, for at least one of the shift stages, the shift circuitry may apply a first shift to the first portion of the group, based on a first term of a redundant representation of the given count value, and apply a second shift to a result of applying the first shift to the first portion of the group, based on a second term of the redundant representation of the given count value. This approach can be helpful to reduce the latency of the resource selection circuitry. The unavailable resource counting circuitry for generating the count values may comprise adding circuitry, which may add respective values derived from the availability information to generate the respective count values for controlling respective stages of shifting. Processing an addition result while represented in a redundant representation (e.g. carry-save representation or a signed-digit representation) comprising two or more separate terms (which are redundant in the sense that multiple different combinations of the two or more terms can map to the same numeric value) can be faster than generating a non-redundant binary representation in which the numeric value is represented non-redundantly using a single term, as processing the addition result in a redundant representation can eliminate the delay of a relatively slow carry-propagate addition used to generate the non-redundant binary representation. For some shift stages (particularly those later stages which are nearer the end of the processing cycle, which depend on a greater number of earlier addition stages in a binary tree of additions used to generate the corresponding count value), waiting for a non-redundant result of the addition may be too slow to meet timing requirements. Hence, by splitting a given shift stage into a first shift based on a first term of a redundant representation (e.g. one of the sum and carry terms of a carry-save representation) and a second shift based on a second term of a redundant representation (e.g. the other of the sum and carry terms), this can cause the shift result to be generated faster, reducing pressure on meeting timing requirements. It is not essential to use this split-shift-stage approach for all shift stages. For example, some of the earlier shift stages may be able to meet timings even if they process the associated count value in a non-redundant representation, so in some implementations the split-shift approach may be used for one or more later shift stages but not all of the shift stages.

In some examples, the first shift stage implemented by the shift circuitry may act on a resource identifier vector which already comprises, in each element position, a full resource identifier of a corresponding one of the resources, including all bits necessary to uniquely identify the corresponding resource. However, in practice, this may incur unnecessary circuit area overhead in shifting resource identifier bits which would be the same for each of the alternative element positions which could be shifted into a given element position following a given stage of shifting.

A more area-efficient approach can be to provide bit injection circuitry to inject, following a given shift stage other than a final shift stage, an additional identifier bit into respective resource identifier elements of the resource identifier vector. More particularly, the bit injection circuitry may inject the additional identifier bit for a given resource identifier element at a most significant bit position of the given resource identifier element. This recognises that in earlier stages of shifts, upper bits of the resource identifiers which would otherwise be shifted within a given group of elements at a given node of the binary tree may be the same for all of the resource identifiers processed in that group. To reduce circuit area, it is therefore not necessary to explicitly represent those upper bits at an early shift stage. Instead, bit injection circuitry may gradually, stage by stage, inject an additional identifier bit into respective resource identifier elements after each stage, so that by the end of the final stage of shifts the resulting contents of each resource identifier element then indicate the resource identifiers of corresponding resources identified as available. With this approach, the total circuit area overhead (and hence power consumption) of the resource selection circuitry can be reduced.

More particularly, if the plurality of shift stages comprise X shift stages, and the set of resources comprises Y resources each identified by an X-bit resource identifier, then for a resource identifier element at a j^{th} element position within a shifted resource identifier vector output by an i^{th} shift stage, where 1≤i≤X−1 and 0≤j≤Y−1, the additional identifier bit injected for that resource identifier element may take the same value as bit [i] of a resource identifier ID[X-1:0] which is equal to j. This can provide the same result as if each element of the original resource identifier vector input for the first shift stage comprised the full resource identifiers, but with a much lower circuit area overhead than if those full identifiers were actually subject to each shift stage.

In some examples, for a given shift stage which processes a given group of resource identifiers with the shift circuitry shifting a number of resource identifier elements from the first portion of the given group into positions within the second portion of the given group, depending on the number of unavailable elements indicated by a portion of the unavailability information corresponding to the second portion of the group, the bit values injected into the resource identifier elements before the given shift stage may be such that the resource identifier elements of the second portion are each injected with a most significant bit of 0 prior to the given shift stage, while the resource identifier elements of the first portion are each injected with a most significant bit of 1 prior to the given shift stage.

Note that it is not necessary for the bit injection circuitry to inject additional bits into every resource identifier element after every stage of the shift circuitry. For example, for some later stages, there may already be some element positions which, when considering that the maximum number of available resource elements to be selected in a given cycle of resource selection is N, cannot contribute to the N elements in the contiguous portion of the resource identifier vector following the final stage of shifting. Hence, any element positions which can no longer contribute to the end result need not have their additional bits injected (and indeed may not necessarily be processed at all in those later shift stages).

The unavailable resource counting circuitry may comprise adding circuitry to add a plurality of elements of availability information corresponding to a given portion of the availability information, to generate the count value for the given portion. The adding circuitry may be implemented using a binary tree of adders, which may gradually build up count values for successively larger portions of the availability information (e.g. portions scaling in size with successive powers of 2), each count value indicating the number of unavailable resources indicated in the corresponding portion of the availability information. It may not be necessary to generate count values for every portion of the availability information in every level of the binary tree of adders, so the binary tree can be asymmetric. By later stages of the adder binary tree, some branches of the tree may become redundant, in a corresponding way to the feature mentioned above where some portions of the resource identifier vector are no longer needed for later stages of shifts once they can no longer contribute to the N element positions in the contiguous portion of the vector used to gather the compacted resource identifier elements corresponding to up to N available resources. Alternatively, a full binary tree including adders for generating a count value corresponding to the number of available resources in the full set of resources could be implemented, to as that full count value can be useful for qualifying how many of the element positions within the contiguous portion of the resource identifier vector actually indicate available resources after the final stage of shifts performed by the shifting circuitry.

As mentioned above, the contiguous portion of the resource identifier vector may comprise a most significant portion of the resource identifier vector or a least significant portion of the resource identifier vector. While the specific examples discussed below implement the contiguous portion as being the least significant portion of the resource identifier vector, other implementations could implement the shift stages using shifts in the opposition direction (e.g. left shifts instead of right shifts), to gather the resource identifier elements of available resources in the most significant portion of the resource identifier vector instead.

The set of resources may comprise a set of processor resources for use by a processor. There can be a wide variety of use cases for resource selection, which in general will face similar issues concerning the challenges of balancing fast resource selection against maintaining performance by ensuring that a given number of available resources are able to be identified regardless of their distribution across the set of resources.

However, one particular use case for which the resource selection circuitry can be beneficial is where the set of resources comprises a set of physical registers and the availability information indicates whether each physical register is available for being mapped to an architectural register by register renaming circuitry. Register reclaim efficiency can be an important contributor to processing performance, since register pressure may be high and so any improvement in the ability to locate freed physical registers which can be remapped to a new architectural register may limit the number of occasions when a processing pipeline is stalled due to insufficient availability of physical registers. Hence, by using the shift based technique described above, in comparison to the segment-based searching approach mentioned earlier, performance can be improved by improving the ability to locate all available registers.

Another use case can be where the set of resources comprises a set of cache entries and the availability information indicates whether each cache entry is available for being allocated with cached information. Similar to the register reclaim example, cache replacement pressure may be high, and it can be desirable to reduce the risk that a given cache entry remains unused when it could have been available for allocation with cached information. The shift-based resource selection approach can be more reliable at identifying the required number of available resources than the alternative segment-based searching approach mentioned earlier. The cache could, for example, be a data cache, instruction cache, translation lookaside buffer or branch prediction cache, or any other type of cache structure for caching information associated with a given subset of memory addresses.

Specific examples are now described with respect to the drawings.

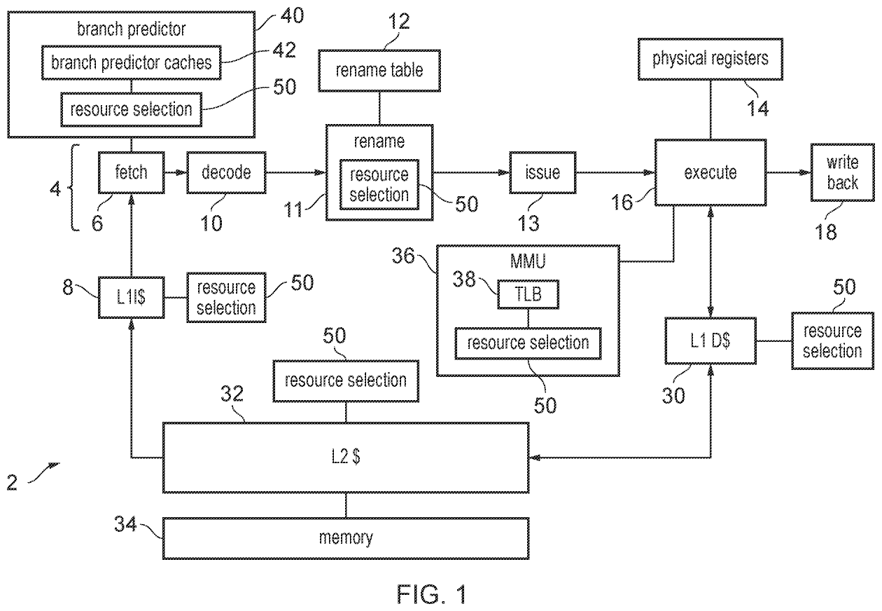

FIG. 1 schematically illustrates an example of a data processing apparatus, e.g. a processor 2. The processor 2 has a processing pipeline 4 which includes a number of pipeline stages. In this example, the pipeline stages include:
a fetch stage 6 for fetching instructions from an instruction cache 8;
a decode stage 10 for decoding the fetched program instructions to generate micro-operations (decoded instructions) to be processed by remaining stages of the pipeline;
a rename stage 11 for maintaining a rename table 12 specifying mappings of architectural registers specified by program instructions or micro-operations to physical register specifiers identifying physical registers in a register file 14;
an issue stage 13 for checking whether operands required for the micro-operations are available in the register file 14 and issuing micro-operations for execution once the required operands for a given micro-operation are available;
an execute stage 16 for executing data processing operations corresponding to the micro-operations, by processing operands read from the register file 14 to generate result values; and
a writeback stage 18 for writing the results of the processing back to the register file 14.
   It will be appreciated that this is merely one example of possible pipeline architecture, and other systems may have additional stages or a different configuration of stages. For example an in-order processor might not have the rename stage 11. Some examples could have additional stages, e.g. for applying backpressure to signal to an earlier pipeline stage that it should reduce the rate of supply of instructions or micro-operations if a later pipeline stage is busy and cannot accept further instructions or micro-operations.

In some examples, there may be a one-to-one relationship between program instructions decoded by the decode stage 10 and the corresponding micro-operations processed by the execute stage. It is also possible for there to be a one-to-many or many-to-one relationship between program instructions and micro-operations, so that, for example, a single program instruction may be split into two or more micro-operations, or two or more program instructions may be fused to be processed as a single micro-operation.

The execute stage 16 may include a number of processing units, for executing different classes of processing operation. For example the execution units may include a scalar arithmetic/logic unit (ALU) 20 performing arithmetic or logical operations on scalar operands read from the registers 14; a floating point unit for performing operations on floating-point values, a branch unit for evaluating the outcome of branch operations and adjusting the program counter which represents the current point of execution accordingly; and a load/store unit for performing load/store operations to access data in a memory system 8, 30, 32, 34. These are just some examples of possible execution units, and others can be provided as well as or instead of the examples given.

A memory management unit (MMU) 36 controls address translation between virtual addresses (specified by load/store requests from the load/store unit of the execute stage 16) and physical addresses (identifying locations in the memory system), with the translation being controlled based on address mappings defined in a page table structure stored in the memory system. The page table structure may also define memory attributes which may specify access permissions for accessing the corresponding pages of the address space, e.g. specifying whether regions of the address space are read only or readable/writable, specifying which privilege levels are allowed to access the region, and/or specifying other properties which govern how the corresponding region of the address space can be accessed. Entries from the page table structure may be cached in a translation lookaside buffer (TLB) 38 which is a cache maintained by the MMU 36 for caching page table entries or other information for speeding up access to page table entries from the page table structure shown in memory.

In this example, the memory system include a level one data cache 30, the level one instruction cache 8, a shared level two cache 32 and main system memory 34. It will be appreciated that this is just one example of a possible memory hierarchy and other arrangements of caches can be provided.

The apparatus 2 also has a branch predictor 40 which may include one or more branch prediction caches 42 for caching prediction information used to form predictions of branch behaviour of branch instructions to be executed by the branch unit 24. The predictions provided by the branch predictor 40 may be used by the fetch stage 6 to determine the sequence of addresses from which instructions are to be fetched from the instruction cache 8 or memory system. The branch prediction caches 42 may include a number of different forms of cache structure, including a branch target buffer (BTB) which may cache entries specifying predictions of whether certain blocks of addresses are predicted to include any branches, and if so, the instruction address offsets (relative to the start address of the block) and predicted target addresses of those branches. Also the branch prediction caches 42 could include branch direction prediction caches (e.g. tables for a TAGE, tagged geometric, predictor) which cache information for predicting, if a given block of instruction addresses is predicted to include at least one branch, whether the at least one branch is predicted to be taken or not taken.

Hence, the data processing system may include a number of cache structures, including for example the data cache 30, instruction cache 8, level 2 cache 32, TLB 38 and/or branch prediction caches 42. It will be appreciated that other types of cache structure could also be provided.

It will be appreciated that FIG. 1 is merely a simplified representation of some components of a possible processor pipeline architecture, and the processor 2 may include many other elements not illustrated for conciseness.

There can be a number of instances within a processor 2 where resource selection circuitry 50 can be provided to select between a set of resources based on availability information indicating which of the resources are available for selection and which of the resources are unavailable for selection. The resources can be physical circuit resources, such as cache entries in one of the cache structures 30, 8, 32, 42, 38 mentioned earlier, or physical registers in the physical register file 14. Hence, FIG. 1 shows a number of instances of resource selection circuitry 50 provided for selecting resources for use in processing instructions, micro-operations or memory access requests.

In the example of FIG. 1, each of the cache structures 30, 8, 32, 42, 38 has a corresponding instance of resource selection circuitry 50 for selecting, when a new cache entry is to be allocated to the cache structure 30, 8, 32, 42, 38 for a new address not previously having any cached information cached in the cache structure, which of the cache entries to select as the entry to be allocated with the information for the new address, based on entry availability information indicating whether each entry is invalid (available for selection) or valid (not available for selection). In the case of a cache entry allocation, if all the entries are valid, a victim selection process may apply a cache replacement policy to select a victim entry to be made invalid so that it can be reallocated for the new address. Nevertheless, it would be preferable in the first instance to select an invalid cache entry if one is available, to avoid needing to evict other valid information if this is not required. In some instances, for improved performance, multiple allocations may be performed into the cache in one cycle. Hence, in general a maximum of N available entries may need to be identified per allocation cycle (with N being 1, 2 or more).

Similarly, in the example of FIG. 1, the rename circuitry 11 comprises resource selection circuitry 50, to select a physical register to be remapped to a destination architectural register specified by a micro-operation supplied to the rename stage 11 for renaming. The physical register to map to the destination architectural register is selected based on a free register list, which is an example of availability information indicating, for each physical register, whether that physical register is available for selection or unavailable for selection. The rename circuitry 11 may be associated with reclaim circuitry which detects when a given physical register previously allocated to an architectural register can be freed for reallocation, and updates the free register list accordingly. For example, a given physical register may be freed once there are no longer any outstanding micro-operations pending in the pipeline which are still to read that given physical register, and once it is guaranteed that there will no longer be a need to restore a register mapping involving that given physical register for handling a flush of the pipeline due to an incorrect speculation such as a branch misprediction by the branch predictor 40 (e.g. the given physical register may be freed once a subsequent instruction specifying the same destination architectural register that was previously mapped to that given physical register commits causing the latest non-speculative register mapping for that destination architectural register to be overwritten with a mapping specifying another physical register other than the given physical register). Given that some micro-operations might be able to specify more than one destination architectural register, and that the rename circuitry 11 could support multiple micro-operations being renamed in parallel in the same cycle to increase throughput, the resource selection circuitry 50 associated with the rename circuitry 11 may need to select multiple free registers per rename cycle. Hence, again, a maximum of N available physical registers 14 may need to be selected by the resource selection circuitry 50 in the rename stage 11 in each cycle of register renaming.

It will be appreciated that FIG. 1 shows just a subset of scenarios in which resource selection circuitry 50 could be provided to select between a set of circuit resources based on availability information. It is not essential for all of the instances of resource selection circuitry 50 shown in FIG. 1 to be provided in a given embodiment.

In some instances, the resource selection circuitry 50 may need to support a relatively high number of resources in the set of resources provided as candidates for selection by the resource selection circuitry 50. For example, the number of resources in the set can be over 100 in some instances (e.g. with relatively large data caches having many entries, or with a large physical register file 14). Often, the resource selection circuitry 50 can be an important contributor to overall circuit performance. This is especially the case for the physical register selection circuitry 50 within the rename stage 11, which may be active every cycle to select new physical registers, and for which processing of a given micro-operation cannot proceed beyond the rename stage until a free physical register is available to map to the micro-operation's destination architectural register.

If the set of resources is large, there can be a challenge in finding the available resources even if they exist, due to the large number of resources, while satisfying a limited timing budget for meeting circuit timing requirements. The greater the number of resources, the greater the pressure on being able to select the available resources within a time period allowed for a single processing cycle based on clock frequencies typically supported by modern processors.

For example, consider a set of 128 resources (e.g. physical registers), with 128 bits of availability information indicating the availability of each resource (e.g. a bit of 1 can indicate an unavailable resource and a bit of 0 can indicate an available resource, or vice versa). A naïve, but slow, technique for searching for up to N available resources in a given cycle (e.g. N=5 or 6) can be to sequentially check each bit of availability information, e.g. in ascending order starting from bit [0], and progressing as far through the set of availability bits towards bit [127] as is necessary until N available resources have been identified (or until all bits have been checked, if there are fewer than N available resources). However, this sequential checking of each bit can be too slow to meet timing requirements.

Therefore, one way of parallelizing the search for available resources can be to split the availability information into segments (e.g. quadrants, namely four segments of availability bits comprising bits [31:0], [63:32], [95:64] and [127:96] respectively). Each quadrant can be processed in parallel, and for each quadrant, a sequential search for available resources is started simultaneously from both ends of the quadrant. For example, for the first quadrant [31:0], a first search starts from the lower end, checking bit [0], then bit [1], then bit [2], and so on until either an available resource is found (if there is any in the quadrant) or bit [15] is reached and found to be unavailable. In parallel, a second search starts from the upper end, checking bit [31], then bit [30], then bit [29], and so on until an available resource (if there is any in this quadrant) is found or bit [16] is reached and found to be unavailable. The other quadrants may be processed in a similar way, in parallel with the first quadrant. With this approach, up to 8 available resources may be identified per cycle, with a parallel approach whose timing scales with the timing required for searching only 16 bits of state sequentially. The number of segments can be varied depending on the size of the pool of resources and the timing budget available.

However, a problem with this segmented search approach can be that it can introduce performance costs, because the available resources may not be distributed evenly in each segment. For example, if 10 available resources are located in segment [95:64] in the example given above, there are no available resources in any other segment, and the resource selection circuitry is searching for up to 6 available resources per cycle, then even though there are more than 6 resources indicated as available in the availability information, as all of the available resources are in the same segment, the resource selection circuitry can only find 2 of these available resources (one starting from the top of segment [95:64] and one starting from the bottom of segment [95:64]), and so performance is lost because some operations which could have proceeded if there were enough available resources identified have to be held back due to not finding all the available resources.

Therefore, it is desirable to provide resource selection circuitry 50 which is faster than a single sequential search of each item of availability information, but which does not introduce performance costs by missing some available resources. In the examples below, the inventors propose a new approach based on stages of shift multiplexing controlled based on counts of the number of unavailable resources indicated by respective portions of the availability information.

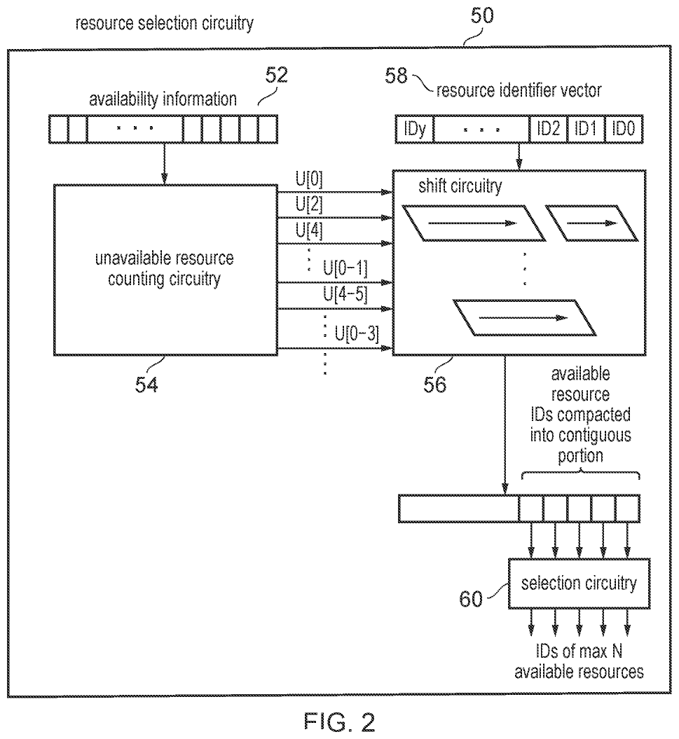

FIG. 2 shows in more detail an example of the resource selection circuitry 50 for addressing these issues. Any one or more of the instances of resource selection circuitry 50 shown in FIG. 1 may comprise the features shown in FIG. 2. It is not essential for all of the instances of resource selection circuitry 50 to have the features shown in FIG. 2, but at least one of the instances of resource selection circuitry 50 may have the features shown in FIG. 2.

The resource selection circuitry 50 shown in FIG. 2 comprises unavailable resource counting circuitry 54, shift circuitry 56 and selection circuitry 60. The unavailable resource counting circuitry 54 receives as an input resource availability information 52 which indicates, for each resource in the pool of resources that are candidates for selection, whether that resource is available for selection or unavailable for selection. In some examples, the availability information 52 can be processed in its raw form without prior pre-processing, e.g. if each element of the availability information is a single bit indicating whether the corresponding resource is available or unavailable. Alternatively, in some examples the availability information may be pre-processed prior to input to the unavailable resource counting circuitry 54. For example, if each element of availability information represents a status of the corresponding resource which can take more than two values, with a subset of those statuses being considered to represent “available” resources and another subset of those statuses being considered to represent “unavailable” resources, then the status information for each resource could be decoded into a bit indicating whether the resource is available or unavailable.

The unavailable resource counting circuitry 54 processes the availability information 52 to generate a set of count values U each corresponding to a given portion of the availability information and representing the number of unavailable resources indicated by that portion of the availability information. The respective portions of the availability information are overlapping and correspond to respective groups of elements of the availability information, each group corresponding to a power-of-2 number of resources. For example, the resource counts may include a set of count values U[0], U[2], U[4], etc. which indicate the number of unavailable resources in corresponding groups of 1 resource (1=2⁰)—these single-resource count values may be derived direct from the availability information 52 without any further arithmetic being required. Other count values U[0-1], U[4-5], etc. may correspond to groups of 2 resources and represent the number of unavailable resource in each group, and may be generated by combining elements of the availability information 52 using an arithmetic/logical operation (e.g. an addition). Similarly, one or more count values U[0-3], etc., may correspond to groups of 4 resources, and so on for further power-of-2 sized groups.

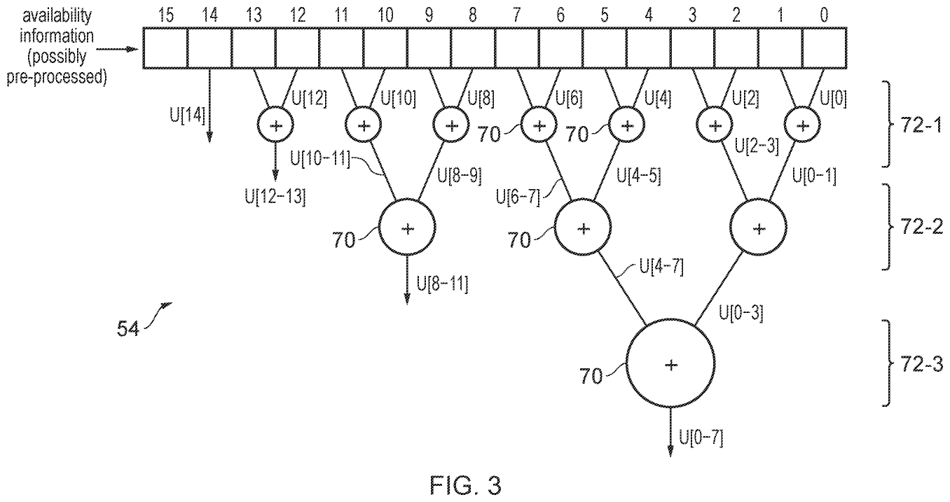

FIG. 3 shows in more detail an example of the unavailable resource counting circuitry 54, which comprises a binary tree of adders 70 arranged in a number of addition stages 72-1, 72-2, 72-3. Each adder 70 represents a node of the tree, and the binary tree is arranged so that each node 70 has a maximum of two parent nodes, with the adder at a given node adding the outputs of its two parent nodes. In the example of FIG. 3, the set of resources comprises 16 resources, and so three stages 72-1, 72-2, 72-3 are sufficient, but it will be appreciated that this could be scaled up to larger numbers of resources by adding further stages.

The single-resource count values U[0], U[2], U[4] for every even-numbered resource are derived direct from the availability information (either in identical form or based on some pre-processing as mentioned earlier). The first adder stage 72-1 comprises a number of adders 70 each of which takes the availability information for a pair of resources with adjacent resource IDs and adds the (possibly pre-processed) availability information for the pair of resources together to generate a count value U[0-1], U[2-3], U[4-5], U[6-7], U[8-9] representing the number of unavailable resources in each pair. Some of these 2-element count values U[2-3], U[6-7] are used only for internal purposes within the unavailable resource counting circuitry 54, for the purpose of generating further count values. Others of the 2-element count values U[0-1], U[4-5], U[8-9] are output for use as inputs to the shift circuitry 56.

The second adder stage 72-2 comprises adders 70 which each add together the 2-element count values from a pair of adders 70 in the first adder stage 72-1, to generate count values U[0-3], U[4-7], U[8-11] each representing the number of unavailable resources in a group of 4 resources having the corresponding resource identifiers 0-3, 4-7 and 8-11 respectively.

The third adder stage 72-3 in this example comprises an adder 70 which adds the 4-element count values U[0-3] and U[4-7] to generate an 8-element count value U[0-7] representing the number of unavailable resources in a group of 8 elements having IDs 0-7.

The binary tree can be asymmetric in the sense that it is not necessary to generate unavailable resource count values for the most significant 2K elements in the K^{th} stage of addition 72-K. Hence, there is no need to generate a 2-element count for resources U[14-15] in stage 72-1, a 4-element count value for resources U[12-15] in stage 72-2, or an 8-element count value for resources U[8-15] in stage 72-3. The circuit area can be reduced by omitting adders 70 from the tree that would be redundant because their outputs would not be needed by the shift circuitry 56.

Alternatively, such redundant count values could be generated anyway, since as mentioned later, it could be helpful in some scenarios to generate a full count value corresponding to the number of unavailable resources indicated by the full set of availability information, even though this is not necessary for controlling shifting, for the purposes of verifying which element positions in the final shifted resource identifier vector 58 actually indicate identifiers of available resources (recognising that in some cycles the total number of available resources may be less than the maximum number of available resources that can be selected per cycle). Hence, while not shown in FIG. 3, in some examples further adders 70 could be provided in stages 72-1, 72-2, 72-3 to calculate U[14-15], U[12-15] and U[8-15] respectively, and an additional adder stage could be provided to add U[0-7] and U[8-15] to compute U[0-15] indicating the total number of unavailable resources in the entire set of 16 resources with resource IDs 0 to 15.

The adder circuitry 70 can be most straightforward if the (possibly pre-processed) input of availability information 52 provided to the adders 70 in the first stage 72-1 is in the format where an input bit U[i]=1 represents an unavailable resource and an input bit U[i]=0 represents an available resource, as in this case a simple addition of subsets of availability indicating bits can be used to generate count values U[x-y] which represent, as a numeric value, the total number of unavailable resources in the group of resources having IDs x to y. However, if the availability information 52 is in the opposite encoding (with U[i]=0 representing an unavailable resource and U[i]=1 representing an available resource), some pre-processing could be applied to invert each bit prior to addition to the adders 70. Alternatively, the adders could operate directly on the availability information with U[i]=0 representing unavailable resources and U[i]=1 representing available resources, and then the output of a given adder 70 could be converted to a value representing the number of unavailable resources in a given group by taking the two's complement (inverting all bits and adding 1) after the adder output is generated. If the availability information is in a more complex encoding, then it can be pre-processed to map it to a single bit of availability information per resource before processing each availability bit in one of the methods described above using the adders.

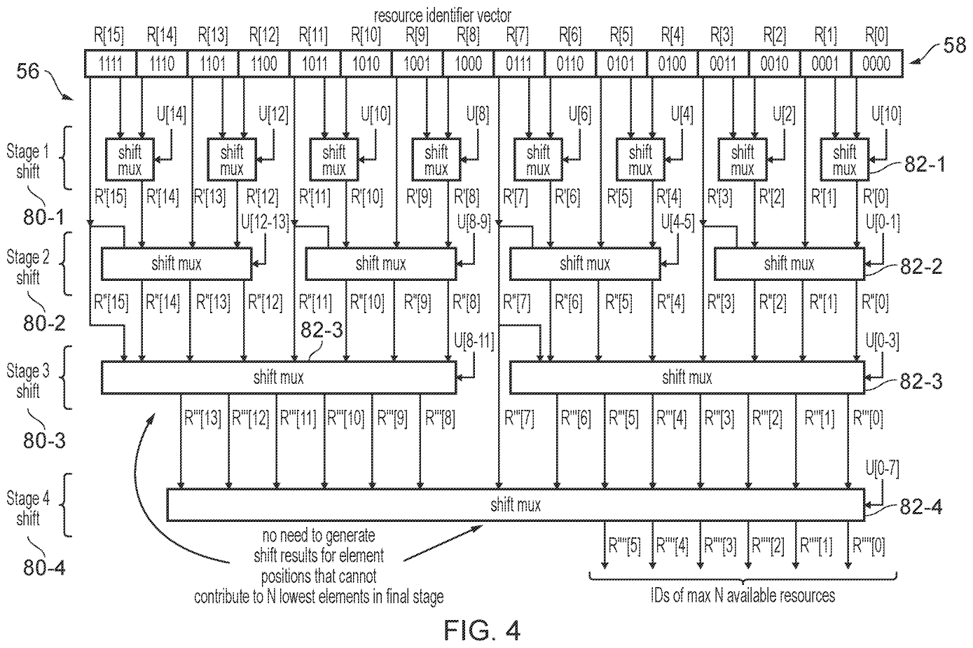

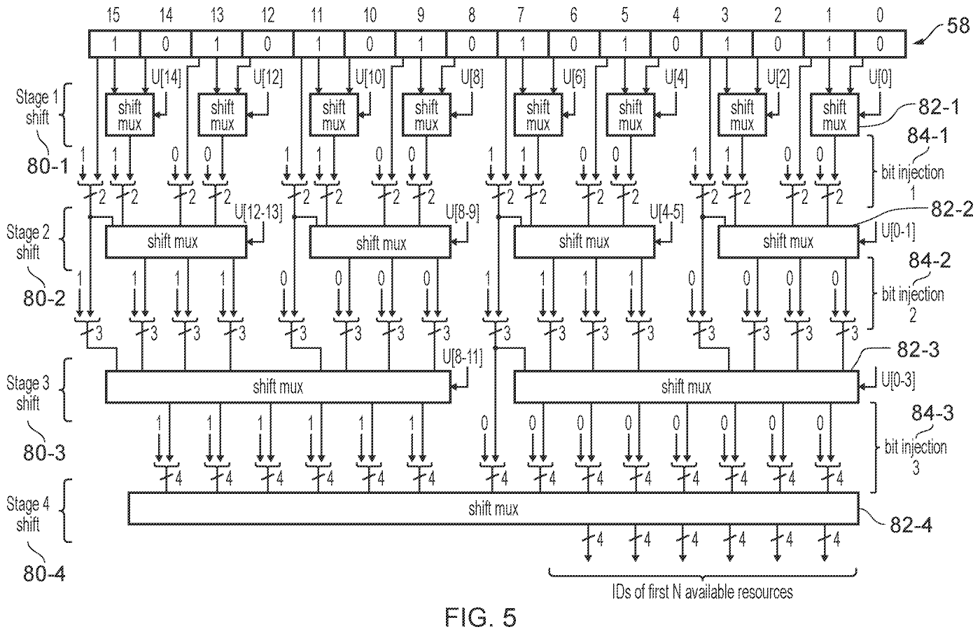

Referring again to FIG. 2, the shift circuitry 56 accepts as input a resource identifier vector 58 comprising a number of resource identifier elements ID0 . . . IDy (where there are y+1 resources in total), each resource identifier element representing at least a portion of the resource identifier of a corresponding one of the resources (ordered in a corresponding order to the elements of availability information 52 so that the element of the availability information at the lowest element position within the availability information 52 indicates the availability of the resource whose identifier is at the lowest element position in the resource identifier vector 58, the element of the availability information at the second lowest element position within the availability information 52 indicates the availability of the resource whose identifier is at the second lowest element position in the resource identifier vector 58, and so on). As explained with reference to the example of FIG. 5 below, it is not essential for the full resource identifier to be provided in each resource identifier element when initially input to the shift circuitry (although this is also possible as shown in FIG. 4), since it is possible to inject additional bits of each resource identifier into the corresponding resource identifier element part way through the stages of shifts applied by the shift circuitry 56.

The shift circuitry 56 also accepts as input a subset of the count values U[0], U[2], U[4], U[0-1], U[4-5], U[0-3], etc. generated by the unavailable resource counting circuitry 54. As mentioned above, it is not necessary for all adder results of adders 70 in the unavailable resource counting circuitry 54 to be supplied to the shift circuitry 56, as some adder results are internal values used for the purpose of generating further count values that are supplied to the shift circuitry 56.

The shift circuitry 56 uses the count values U generated by the unavailable resource counting circuitry 54 to perform a series of shift stages, each shift stage applying one or more shifts to respective groups of resource identifier elements of the resource identifier vector 58, where for each group the shift circuitry 56 selectively shifts one or more elements of a first portion of a given group by a given number of element positions into positions within a second portion of a given group, where the given number of element positions depends on one of the count values U provided by the unavailable resource counting circuitry that indicates the number of unavailable elements within the second portion of the given group.

After applying a number of shift stages which operate on groups with the size of the second portion scaling with successively increasing power-of-2 numbers of resource identifier elements, the effect is to compact the resource identifier elements corresponding to available resources into a contiguous portion of the resource identifier vector (e.g. in the examples discussed below, the contiguous portion is the least significant N elements of the resource identifier vector, where N is the maximum number of resources to be selected in a given cycle). Hence, the selection circuitry 60 can simply read out the identifiers of the available resources to be selected from the lowest N positions of the shifted resource identifier vector, to identify which resources are available to select.

If there are fewer than N available resources indicated by the availability information 52, a placeholder value (such as the maximum possible resource identifier, or a dummy resource identifier) can be shifted into some of the N contiguous positions, which can either directly indicate that there are fewer than N available resources available, or if the number of resources is an exact power of 2, the shifted in value in the case of having fewer than N available resources may correspond to a real resource identifier, and so can be qualified by the selection circuitry 60 using the corresponding element of availability information 52 for the resource ID corresponding to the shifted in value to check whether there is really an available resource having that ID, to prevent an unavailable resource being selected if there are fewer than N resources available in a given cycle. Another alternative could be that, as mentioned above, the adder stages of unavailable resource counting circuitry 54 could also calculate a count value U[0-15] covering the entire set of resources, which could be used to determine how many available resources there are in total, and that count value could be used to prevent the selection circuitry 60 selecting the identifiers from element positions that go beyond the actual number of available resources, in cycles where fewer resources are available than the maximum number N able to be selected per cycle.

Hence, the shift circuitry 56 compacts the resource identifier elements of up to N resources into a contiguous portion of the resource identifier vector, based on the count values representing numbers of unavailable resources generated by the unavailable resource counting circuitry 54. An example of the shift circuitry 56 (corresponding in design to the example of the unavailable resource counting circuitry 54 shown in FIG. 3) is shown in FIG. 4, again for an example where the total number of resources in the set provided as candidates for selection is 16 resources (with IDs 0 to 15). In this example, the maximum number of resources N that can be selected in a given cycle is N=6. In the example of FIG. 4, the resource identifier vector 58 comprises 16 resource identifier elements which, in the initial input to the shift circuitry 56, already comprise full resource identifiers of the corresponding resources (hence, the resource identifiers having binary encodings 0b0000 to 0b1111 in ascending order of resource element position within the resource identifier vector 56, although it would be possible to have the resource elements in a different order provided that the availability information 52 is ordered in a corresponding order)

The shift circuitry 56 comprises a series of shift stages 80-1 to 80-4. In the first shift stage 80-1, a number of shift multiplexers 82-1 are provided, each acting on a group of 2 neighbouring resource identifier elements of the resource identifier vector 58. For each group, the group can be considered to include an upper portion (first portion) of one element and a lower portion (second portion) of one element. The corresponding shift multiplexer 82-1 selects, based on the single-element count value U[k] (k is an even number) indicating whether the corresponding resource represented by the resource identifier R[k] in the lower portion of the group is unavailable for selection, whether to shift the resource identifier element R[k+1] into the lower portion of the group. Hence, the outcomes of each shift multiplexer 82-1 in the first shift stage 80-1 can be as follows, depending on the value of U[k], the count of the number of unavailable elements in a single-resource group comprising resource ID k, where R[k] and R[k+1] represent the resource identifier elements for positions k and k+1 respectively as input to the first shift stage 80-1 and R′[k] and R′[k+1] represent the shifted output for those positions within the resource identifier vector:

### Shift Multiplexer 82-1 Logic

| | | R′[k] Shift output | |
|---|---|---|---|
| U[k] | R′[k + 1] | for position [k] | Comment |
| 1 (resource k | R[k + 1] or P | R[k + 1] | 1 unavailable resource |
| unavailable) | | | in lower half of group, |
| | | | so shift 1 resource |
| | | | from upper half into |
| | | | lower half |
| 0 (resource k | R[k + 1] | R[k] | 0 unavailable |
| available) | | | resources in lower half |
| | | | of group, so no shift |
| | | | necessary |

This produces a series of values R′[0] to R′[15] which represent the output of the first shift stage 80-1. Note that for odd values of k, R′[1], R′[3], etc. in the shifted output may in some examples be unchanged compared to the corresponding input R[k] to the first shift stage 80-1, so do not require a multiplexer to select these values. Alternatively, P is a placeholder value that could be injected for the upper element of a pair in the case of a 1-position shift being applied based on U[k]=1, to represent that there is no real resource represented for the output of R′[k+1]-such use of placeholder values (e.g. a dummy resource identifier which is not a real identifier value) can help to distinguish cases where there are fewer than N available resources indicated by the availability information. However, a dummy resource identifier may not be possible if there is an exact power of 2 number of resources (as in this example, although other examples may have a number of resources that is not an exact power of 2, leaving some encodings of resource identifiers available for use as the placeholder value P). Alternatively, if the values R[i] for each element position are expanded by an additional bit then even with a power-of-2 number of resources the additional bit would allow for a free encoding to be used as the placeholder value P which does not correspond to a real identifier value. In any case, it is not essential to inject a placeholder value P, as even if a real resource identifier value R[k+1] is injected at the upper end when a shift by a non-zero number of positions is required, the selection circuitry 60 could determine whether the final shifted result of the final shift stage 80-4 represents real identifiers of available resources by qualifying the identifiers output at those positions using the availability information 52 for the corresponding element positions indicated by the identifiers.

The second shift stage 80-2 comprises a number of shift multiplexers 82-2 each of which acts on a group of four resource identifier elements R′[k] to R′[k+3] output by the first shift stage 80-1, where for the second shift stage 80-2 k is a multiple of 4 (k=0, 4, 8, etc.). Each group can be considered to comprise an upper portion (first portion) of 2 elements R′[k+2] and R′[k+3] and a lower portion (second portion) of 2 elements R′[k] and R′[k+1]. A given shift multiplexer 82-2 shifts, by a number of element positions indicated by the count value U[k-k+1] indicating the number of unavailable resources corresponding to resource identifiers in the lower portion of the group, the resource identifier elements R′[k+2−k+3] of the upper portion of the group into the positions within the lower portion of the group. As there are two elements in the lower portion of the group, U[k−k+1] can take a value of either 0, 1 or 2, so the shift multiplexer 82-2 logic becomes as follows, where R′[k] to R′[k+3] are the outputs of the first shift stage 80-1 for element positions k to k+3 (k is a multiple of 4), R″[k] to R″[k+3] are the shifted outputs of the second shift stage 80-2 for those element positions, U[k−k+1] represents the count value indicating the number of unavailable resources in the set of resources having identifiers k and k+1, and P again represents the option to inject a placeholder value instead of a real resource identifier if a non-zero number of unavailable elements is indicated by U[k−k+1]:

### Shift Multiplexer 82-2 Logic

| U[k − k + 1] | R″[k + 3] | R″[k + 2] | R″[k + 1] | R″[k] |
|---|---|---|---|---|
| 2 | R′[k + 3] | R′[k + 3] | R′[k + 3] | R′[k + 2] |
| | or P | or P | | |
| 1 | R′[k + 3] | R′[k + 3] | R′[k + 2] | R′[k] |
| | or P | | | |
| 0 | R′[k + 3] | R′[k + 2] | R′[k + 1] | R′[k] |

Note that for the case where U[k-k+1] is 1, then as highlighted by the cell shown in bold, R″[k]=R′[k], i.e. the element at position k is unchanged by the shift and the shift in of 1 element position affects the top element R″[k+1] of the lower group, which will become set to R′[k+2]. This will reflect the fact that R′[k] should be preserved if U[k-k+1]=1 because there will be an identifier for an available resource indicated by R′[k] that was already positioned at R′[k] following the first shift stage 80-1. Similarly, the earlier shift applied in stage 82-1 to generate the upper portion R′[k+3] and R′[k+2] may already have set R′[k+2] to either R[k+2] or R[k+3] depending on whether R[k+2] corresponds to an available resource, so regardless of the specific count values for a given cycle, the combination of the first two stages has the result that, within a group R[k] to R[k+3] of the original resource identifier vector 58, the first 2 available resources in the group (if there are at least two available resources in that group) will have become shifted into the lower 2 positions of R″[k] to R″[k+3], or alternatively if the group of resources with IDs k to k+3 only has 0 or 1 available resources, then the lower 2 positions could include some identifiers of unavailable resources or placeholder values, which may get overwritten by shifted in elements in a later shift stage. As in stage 80-1, in stage 80-2, the top position R″[k+3] may not require any multiplexing logic if it is passed through unchanged without use of the placeholder value P, or alternatively if a placeholder value P is used then a multiplexer may select between R′[k+3] and P for position R″[k+3].

The third shift stage 80-2 comprises shift multiplexers 82-2 each of which acts on a group of eight resource identifier elements R″[k] to R″[k+7] output by the second shift stage 80-2, where for the third shift stage 80-3 k is a multiple of 8 (k=0, 8, etc.). Each group can be considered to comprise an upper portion (first portion) of 4 elements and a lower portion (second portion) of 4 elements. A given shift multiplexer 82-3 shifts, by a number of element positions indicated by the count value U[k-k+3] indicating the number of unavailable resources corresponding to resource identifiers in the lower portion of the group, the resource identifier elements R″[k+4-k+7] of the upper portion of the group into the positions within the lower portion of the group. As there are four elements in the lower portion of the group, U[k-k+3] can take a value of either 0, 1, 2, 3 or 4, so the shift multiplexer 82-2 logic becomes as follows, where R″[k] to R″[k+7] are the outputs of the second shift stage 80-2 for element positions k to k+7 (k is a multiple of 8), R″[k] to R″[k+7] are the shifted outputs of the third shift stage 80-3 for those element positions, U[k-k+3] represents the count value indicating the number of unavailable resources in the set of resources having identifiers k to k+3, and P again represents the option to inject a placeholder value instead of a real resource identifier if a non-zero number of unavailable elements is indicated by U[k−k+3]:

### Shift Multiplexer 82-3 Logic

| U[k- | | | | | | | | |
|---|---|---|---|---|---|---|---|---|
| k + 3] | R″′[k + 7] | R″′[k + 6] | R″′[k + 5] | R″′[k + 4] | R″′[k + 3] | R″′[k + 2] | R″′[k + 1] | R″′[k] |
| 4 | R″[k + 7] | R″[k + 7] | R″[k + 7] | R″[k + 7] | R″[k + 7] | R″[k + 6] | R″[k + 5] | R″[k + 4] |
| | or P | or P | or P | or P | | | | |
| 3 | R″[k + 7] | R″[k + 7] | R″[k + 7] | R″[k + 7] | R″[k + 6] | R″[k + 5] | R″[k + 4] | R″[k] |
| | or P | or P | or P | | | | | |
| 2 | R″[k + 7] | R″[k + 7] | R″[k + 7] | R″[k + 6] | R″[k + 5] | R″[k + 4] | R″[k + 1] | R″[k] |
| | or P | or P | | | | | | |
| 1 | R″[k + 7] | R″[k + 7] | R″[k + 6] | R″[k + 5] | R″[k + 4] | R″[k + 2] | R″[k + 1] | R″[k] |
| | or P | | | | | | | |
| 0 | R″[k + 7] | R″[k + 6] | R″[k + 5] | R″[k + 4] | R″[k + 3] | R″[k + 2] | R″[k + 1] | R″[k] |

Again, the elements highlighted in bold are the elements which remain unchanged by the shift, since these would represent identifiers of available resources in the lower (second) portion that should be preserved. Depending on the number of unavailable resources in the lower portion, some resource identifier elements of the upper portion of each group are shifted into one or more upper positions within the lower portion by a number of element positions indicated by U[k-k+1] and any remaining lower elements in the lower portion retain their previous values.

Note that, as shown in the example of FIG. 4, for shift stage 80-3 in this example it is not essential for the shift multiplexer corresponding to k=8 to calculate positions R″[14] or R′″[15], because when considering the fact that the final shift stage 80-4 in this example shifts by a maximum of 8 element positions and only N=6 available resources can be selected as the maximum number of available resources, the total number of positions from which those 6 available resources can be selected will be 14 positions, so it is sufficient for the penultimate shift stage 80-3 to calculate only R′″[0] to R′″[13] and omit calculating R″[14] and R″[15]. Hence, the shift multiplexer 82-3 that generates R″[8] to R″[15] in the third shift stage 80-3 may be truncated in comparison to the shift multiplexer 82-3 that generates R″[0] to R″[7]. It will be appreciated that the particular shift stages 80 and multiplexers 82 for which such truncation occurs will depend on the total number of resources in the pool provided as candidates for selection (16 in this example) and the maximum number N of resources to be selected per cycle (6 in this example).

Finally, the fourth and final shift stage 80-4 in this example comprises a multiplexer 82-4 which takes as inputs R′″[0] to R″[13] as output by the third shift stage 82-3, treated as a single group comprising an upper portion (first portion) of 6 elements and a lower portion (second portion) of 8 elements. The shift multiplexer 82-4 in the final stage 80-4 shifts, by a number of element positions indicated by the count value U[0-7] indicating the number of unavailable resources corresponding to resource identifiers in the lower portion of the group, the resource identifier elements R″[8] to R′″[13] of the upper portion of the group into the positions within the lower portion of the group. As there are 8 elements in the lower portion of the group, U[0-7] can take any value between 0 and 8, so the shift multiplexer 82-2 logic becomes as follows, where R″[0] to R′″[13] are the outputs of the third shift stage 80-3 for element positions 0 to 13 respectively, R″″[0] to R″″[5] are the shifted outputs of the fourth and final shift stage 80-4 for element positions 0 to 5 (as a maximum of N=6 identifiers need to be selected per cycle, there is no need to calculate shifted outputs for columns 6 onwards), U[0-7] represents the count value indicating the number of unavailable resources in the set of resources having identifiers 0 to 7, and P again represents the option to inject a placeholder value instead of a real resource identifier if a non-zero number of unavailable elements is indicated by U[0-7]:

### Shift Multiplexer 82-4 Logic

| U[O- | | | | | | |
|---|---|---|---|---|---|---|
| 7] | R″″[5] | R″″[4] | R″″[3] | R″″[2] | R″″[1] | R″″[0] |
| 8 | R″′[13] | R″′[12] | R″′[11] | R″′[10] | R″′[9] | R″′[8] |
| 7 | R″′[12] | R″′[11] | R″′[10] | R″′[9] | R″′[8] | R″′[0] |
| 6 | R″′[11] | R″′[10] | R″′[9] | R″′[8] | R″′[1] | R″′[0] |
| 5 | R″′[10] | R″′[9] | R″′[8] | R″′[2] | R″′[1] | R″′[0] |
| 4 | R″′[9] | R″′[8] | R″′[3] | R″′[2] | R″′[1] | R″′[0] |
| 3 | R″′[8] | R″′[4] | R″′[3] | R″′[2] | R″′[1] | R″′[0] |
| 2, 1 | R″′[5] | R″′[4] | R″′[3] | R″′[2] | R″′[1] | R″′[0] |
| or 0 | | | | | | |

Note that it is not necessary to distinguish the cases where U[0-7] is 2, 1 or 0, because in each of those cases there will be at least 6 available elements with identifiers already shifted into the lower portion R″″[5] to R′″[0] of the vector before the start of the fourth shift stage 80-4, which provides enough available resources for the maximum number N=6 to be selected per cycle. In cases where U[0-7] is 3 or more, there will be at least one unavailable resource having an identifier indicated in R′″[5] to R″[0] at the output of the third shift stage 80-3, and so at least one element from the upper portion R″[13] to R″[8] is shifted into the window of N elements R″″[5] to R′″[0] of the output of the final shift stage 80-4. The elements shown in bold in the table above are again unchanged by the shift, to preserve the elements which already indicate identifiers of available resources prior to the final shift stage 80-4.

Hence, by the final shift stage, the N positions at the lower contiguous portion of the final shifted resource identifier vector, R″″[5] to R″″[0], will either contain:
identifiers of the first N available resources, if the total number of available resources is N or more. The selection circuitry 60 can simply read out the values of the first N positions in the final shifted resource identifier vector, to identify the identifiers of the N resources to be selected in the current cycle.
or
identifiers of all the available resources, if the total number of available resources is less than N. In this case one or more upper positions of elements R″″[5] to R″″[0] may contain placeholder values P or could contain arbitrary identifier values. The selection circuitry 60 can identify which resources are actually available, by ignoring one or more upper positions R″″[5], R′″[4] etc. which either specify placeholder values P or are qualified as not representing an available resource based on the availability information (e.g. by using extra adder stages to calculate how many available resources are present in total as mentioned above, and avoiding reading beyond that number of lowest positions within the contiguous portion R″″[5] to R″″[0] of the shifted resource identifier vector).
   Either way, no further decoding of the resource identifiers is necessary, as the output of the final shift stage 80-4 already indicates the identifiers of the available resources.

With this approach, there is no possibility that the resource selection circuitry 50 would miss any available resources, unlike the segmented search approach described above. Regardless of the distribution of available resources among the pool of resources, if there are N or more available resources, the identifiers of the first N available resources will be compacted into the contiguous portion R″″[5] to R″″[0] of the resource identifier vector, and if there are fewer than N available resources, all available resources will be identified.

Also, the binary tree approach means that the timing performance is much faster than a purely sequential search checking each availability element of the availability information 52 in turn.

The approach shown in FIG. 4 can work, but requires more circuit area than is necessary to incur for the shift multiplexing. Note that in shift stage 80-1 of FIG. 4, for a given shift multiplexer 82-1 processing resource identifier elements for adjacent positions R[k] and R[k+1] where k is an even number, all but the least significant bit of the resource identifier for R[k] will equal the corresponding bits in R[k+1], so that it is not in fact necessary to carry out any multiplexing selection for those bit positions—the shift multiplexers 82-1 in shift stage 80-1 can be reduced to selecting the least significant bit only, and the upper bits of each identifier can be injected subsequently ahead of later shift stages. Similarly, in the second shift stage 82-2, all but the lower two identifier bits in elements R′[k] to R′[k+3], where k is a multiple of 4, will be the same for all of those elements, so regardless of the result of the shift would be the same in the output R″[k] to R″[k+3] of the second shift stage 82-2. Hence, again this means it is not necessary to represent the upper 2 bits explicitly in the resource identifier elements shifted by the second shift stage 82-2, and instead such upper 2 bits can be injected later.

Hence, as shown in the example of FIG. 5, a number of stages 84-1 to 84-3 of bit injection circuitry may be provided so that, in the first shift stage 80-1, each resource identifier element of the resource identifier vector 58 comprises only the least significant bit of the resource identifiers that would have been indicated in that position in the example of FIG. 4, and following each shift stage 80-i other than the final stage 80-4, the next bit of the respective resource identifier is injected prior to performing the subsequent shift stage 80-i+1. In other words, if there are X shift stages in total (i.e. X=4 for this example), and there are Y resources each identified by an X-bit resource identifier (e.g. 16 resources identified by 4-bit IDs in this example), then for a resource identifier element at a j^{th} element position within a shifted resource identifier vector output by an i^{th} shift stage, where 1≤i≤X−1 and 0≤j≤Y−1, the additional identifier bit injected for that resource identifier element prior to the (i+1)th shift stage has the same value as bit [i] of a resource identifier ID[X-1:0] which is equal to j. For example, the series of bits injected for element position [5] in FIG. 5 is such that, before shift stage 80-1 the bit injected as R[5] is 0b1 (bit [0] of the 4-bit identifier [3:0] for R[5]), between shift stages 80-1 and 80-2, the bit injected as the most significant bit of R′[5] is 0b0 (bit [1] of the 4-bit identifier [3:0] for R[5]), between shift stages 80-2 and 80-3, the bit injected as the new most significant bit of R″[5] is 0b1 (bit [2] of the 4-bit identifier [3:0] for R[5]), and between shift stages 80-3 and 80-4, the bit injected as the new most significant bit of R″[5] is 0b0 (bit [3] of the 4-bit identifier [3:0] for R[5]). This works because the series of bits (from most significant to least significant, i.e. in reverse order compared to the order in which they are injected) is 0b0101 which indeed corresponds to identifier 5 in a decimal notation.

This bit injection pattern can also be viewed as injecting 0s into the element positions which will correspond to the lower portion (second portion) of the group handled by a given shift multiplexer 84-i in shift stage 80-i and injecting 1s into the element positions which will correspond to the upper portion (first portion) of the group handled by a given shift multiplexer 84-i in shift stage 80-i. As shown in FIG. 5, for a complete symmetric binary tree, this means each stage 84-i of the bit injection circuitry injects an alternating pattern of (i+1) 0s followed by (i+1) 1s into the elements at element positions from 0 to 15, with alternating groups of 2 0s followed by 2 1s in bit injection stage 84-1, alternating groups of 4 0s followed by 4 1s in bit injection stage 84-2 and alternating groups of 8 0s followed by up to 8 1s in bit injection stage 84-3.

By using such bit injection circuitry, this avoids shifting around bits of state which would be the same for every element position handled by a given shift multiplexer 82-1, 82-2, 82-3, 82-4, to reduce the total circuit area and power consumption incurred by the shift circuitry 56.

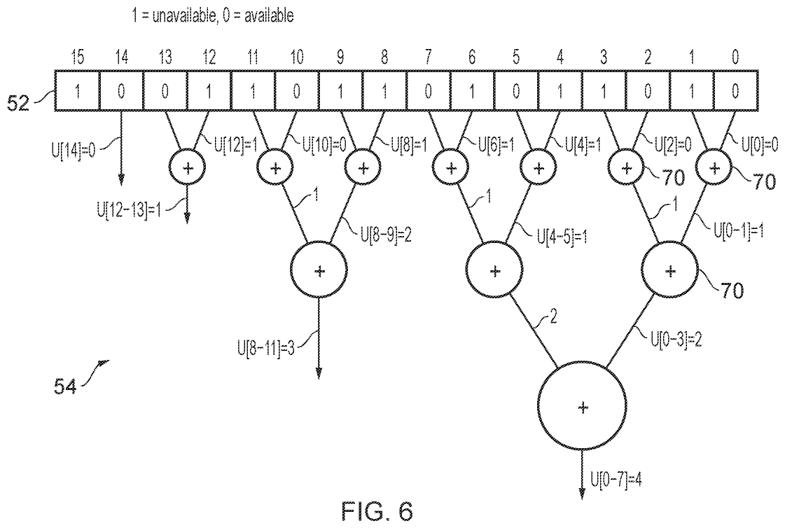

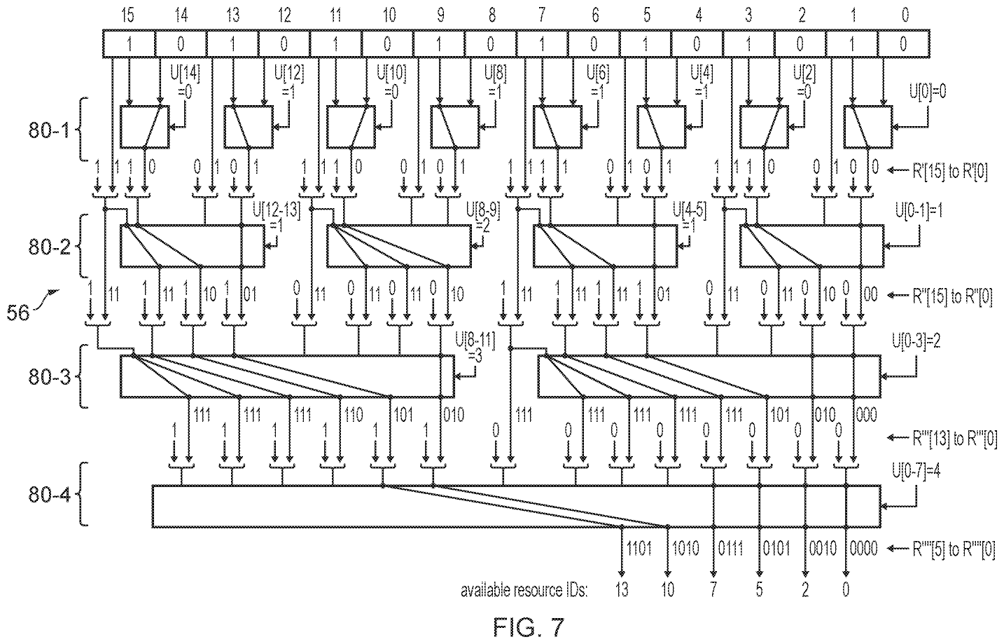

FIGS. 6 and 7 illustrate a worked example based on the example of FIG. 5 (including the bit injection circuitry 84). As shown in FIG. 6, with an encoding of the availability information 52 in which U[i]=1 indicates that the resource with resource ID=i is unavailable and U[i]=0 indicates that the resource with resource ID=i is available, in this particular example the resource availability is such that the available resources are resources with IDs 0, 2, 5, 7, 10, 13 and 14. As shown in FIG. 6, the binary tree of adders in unavailable resource counting circuitry 54 generates various count values corresponding to the number of unavailable resources in corresponding groups of resources of sizes ranging from 1 resource per group to 8 resources per group. FIG. 6 shows the U labels only for those resource count values that will be used by the shift circuitry 56 to control the shift multiplexing, but also the values of various internal count values are shown (without U labels) which are used by subsequent adders to calculate some of the other count values which are used as inputs to the shift circuitry 56.

As shown in FIG. 7, the shift circuitry takes those count values U and uses them to control the shift multiplexing in each shift stage 80-1 to 80-4, so that in this example:
in shift stage 80-1:
   For k=0, 2, 10 and 14, U[k]=0 and so elements R[k] and R[k+1] are passed through unchanged with no shift applied (since the element at the lower element position k is identified as an available element).
   For k=4, 6, 8, 12, U[k]=1 and so element R[k+1] is shifted down one position to become R′[k], so that the identifier R[k] of the unavailable element is overwritten with the identifier R[k+1] which may or may not be available.
ahead of shift stage 80-2, an extra bit 0 or 1 is injected at the most significant end of each element position R′[k] so that the injected bit matches the second most significant bit of a binary representation of k;
in shift stage 80-2:
   For k=0, 4, 12, U[k-k+1]=1, and so while element R″[k]=R′[k], elements R′[k+3] and R′[k+2] are shifted up one position to become R″[k+2] and R″[k+1]. This means that the one available element in the lower half of each group with k=0, 4, 12 has its identifier preserved, but the other element is overwritten with an identifier from the upper half of each group.
   For k=8, U[8-9]=2 and so both of the elements R′[9], R′[8] in the lower half would identify placeholders or unavailable element identifiers, and so in the output R″[9] and R″[8] become overwritten with the values of R′[11] and R′[10] respectively from the upper half of that group.
ahead of shift stage 80-3, a further bit is injected at the most significant end of element position R″[k] so that the injected bit matches the third most significant bit of a binary value of k;
in shift stage 80-3:
   U[0-3]=2 and so while the lower 2 elements R′″[0] and R′″[1] keep their previous values R″[0], R″[1] from the previous stage (subject to bit injection), as these will represent the identifiers of the 2 available elements in the lower part of the group, the next 2 elements R″[2] and R′″[3] are overwritten with elements shifted across from the upper 4 elements of the group;
   U[8-11]=3 and so for this group only the lower element R″[8] keeps its previous value R″[8] and the next 3 elements R″[9] to R′″[11] are shifted across from elements R″[12] to R″[14] respectively.
ahead of shift stage 80-4, the final most significant bit of a binary representation of k is injected into the elements at each position R″[k];
in shift stage 80-4:
   U[0-7]=4 and so the lower 4 elements R′″[0] to R′″[3] stay in their positions to become R′″[0] to R″″[3] but the next 2 elements R″″[4] and R″″[5] are set based on R″[8] and R″″[9] respectively, which correspond to the first 2 available elements indicated by the upper half of the availability information shown in FIG. 6.
      As shown in FIG. 7, the final result of this series of shifts and bit injections is that the values in the lowest 6 element positions R″″[0] to R″″[5] correspond to binary identifier values 0b0000, 0b0010, 0b0101, 0b0111, 0b1010, 0b1101 corresponding to resources 0, 2, 5, 7, 10 and 13 respectively, which matches the positions of the first 6 0s shown in the availability information 52 in FIG. 6.

As shown in FIGS. 3 and 6, the unavailable resource counting circuitry 54 comprises a binary tree of adders 70. If each adder 70 is implemented as a carry propagate adder to generate a non-redundant binary representation of each count value U to be used as input to the shift stage, then for later stages of the addition it might become challenging to meet circuit timings, particularly if the number of resources is larger than 16 so that more than 4 stages of addition are required.

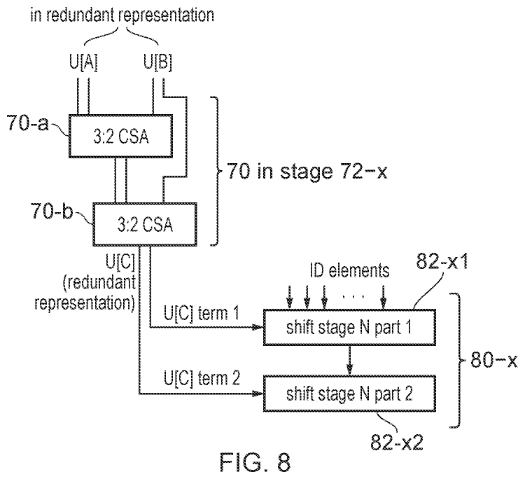

FIG. 8 shows an example which can address this timing issue. As shown in FIG. 8, a given adder 70 in a given adder stage 72-x can be implemented using two carry save adders 70-a, 70-b which take as inputs two input count values each represented in redundant representation using two separate terms, a sum term and a carry term (for the first stage of adders 72-1, for each input count value, the carry term can be 0 and the sum term can be set based on the raw or pre-processed value of the corresponding bits of availability information, and for later stages of adders 72-2 onwards the sum/carry terms may derive from the redundant output of a corresponding second carry-save adder 70-b in the previous stage). Each carry-save adder 70-a, 70-b performs a 3:2 carry save add reduction to convert 3 inputs to 2 results in carry-save notation. Therefore, as the inputs to adder 70 in stage 72-x have 4 terms, two sub-stages of carry-save adders 70-a, 70-b are needed to reduce the 4 terms to 2.

For at least some of the adder stages 72-x, the corresponding U count value may be output to the shift circuitry 56 still in the redundant carry-save representation, rather than first calculating a non-redundant output by adding the two redundant terms using a carry propagate adder. This makes the redundant U count values available as input to the shift circuitry 56 at an earlier timing than if a carry propagate adder was used to generate a non-redundant count value, because the carry save adders 70-a, 70-b can process each bit of the count values in parallel rather than requiring a sequential ripple of carries up from least significant bit to most significant bit.

In the shift circuitry 56, the corresponding stage 80-x which receives the count value from the adder 70 in stage 72-x can similarly be implemented in split form using two sub-shifters 82-x1, 82-x2 which respectively take as inputs the respective sum/carry terms generated by the second carry save adder 70-b in the corresponding addition stage 72-x (the carry term may be notionally left-shifted by one bit position prior to being used to control the second shift sub-stage 82-x2, to reflect that carries from one position in an addition are injected at the next most significant bit position if they were added to the sum term in a carry-propagate addition). This split-shift approach is based on a recognition that a shift by (A+B) element positions can be equivalent to a shift by A element positions followed by a shift of B element positions. Alternatively, the first shift stage can be seen as redundantly generate candidate values for every possible value of the second redundant term of the redundant representation of the count value, and then the second shift stage 82-x2 can select between the redundant values for each element position based on the second redundant term generated by adder 70-b.

Hence, by processing the count value U indicating the number of unavailable resources in the lower portion of a group of resources in a redundant form, at least for later stages of the addition/shift, this can reduce timing pressure by enabling the redundant representation of the count value U to be available earlier and hence the shift to start at an earlier timing in the cycle.

It will be appreciated that it is not essential to use the split-shift approach shown in FIG. 8 for all stages. For some implementations, the number of resources in the set and the circuit timing budget available may be such that it is possible to generate each count value U in a non-redundant binary two's complement notation before inputting the non-redundant value to the shift circuitry 56, to avoid needing two separate sub-shifters 82-x1, 82-x2 in the same shift stage 80. However, for other implementations, splitting at least one or more of the later shift stages 80 into two parts 82-x1, 82-x2 controlled based on separate redundant terms of a redundant representation of the corresponding count value U can be helpful for meeting circuit timings. It is not essential for this split shift technique to be used for all shift stages 82. Only the subset of shift stages 82 which are most sensitive to timing compliance may use the split shift approach. The particular point of the shift binary tree at which the split shift approach starts to be used can depend on the needs of a given implementation.

The examples discussed above are based on a full binary tree where at least the earlier add/shift stages 72, 80 are complete, given the set of resources comprises a full power-of-2 number of resources with a continuous range of resource identifiers extending from 0 to 2^{Y}−1.

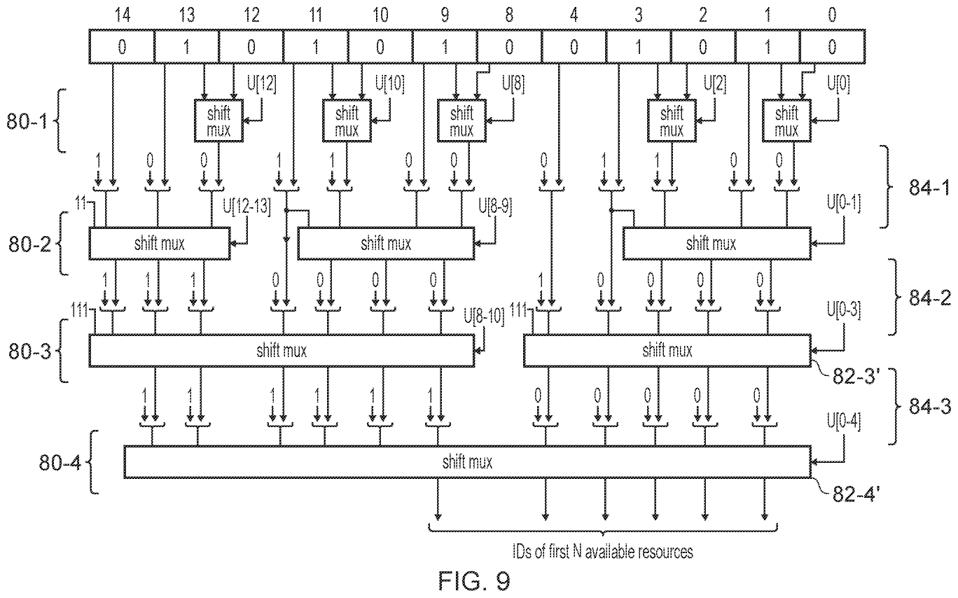

However, as shown in FIG. 9, in some scenarios of resource selection, there may not be an exact power of 2 number of resources, and there could in some examples be a discontinuity of the resource identifiers. For example, with the use case of physical register selection by resource selection circuitry 50 in the rename stage 11, the register selection may be from multiple banks of registers, not all of which comprise an exact power-of-2 number of registers. Physical register identifier decoding can be simpler if, for each bank, the ID of the first register in the bank starts from an exact power of 2. Hence, if the previous bank does not have an exact power of 2 number of registers, there can be a gap in the range of register identifiers available.

For example, in the simplified example of FIG. 9 the resource identifiers comprise resources 0-4 and resources 8-14 with a discontinuity where there are no valid resources with identifiers 5-7. It will be appreciated that the number of resources in this example is reduced for ease of explanation, so in practice it is likely that discontinuities would arise after the identifiers corresponding to a greater number of resources than 5. However, FIG. 9 is a simplified example to illustrate how this can be handled within the shift binary tree of shift circuitry 56.

As shown in FIG. 9, for column positions which do not correspond to any valid resource identifier, the corresponding shift multiplexer logic and bit injection logic can be eliminated. For example, the shift multiplexer logic for column positions 5 to 7 and 15 from the example of FIG. 5 is removed in the example of FIG. 9. This means that some of the shift multiplexers shown in FIG. 5 may be removed entirely (e.g. in FIG. 9 there is no longer any need for shift multiplexers 82-1 corresponding to element positions 4-5 and 6-7 as shown in the first shift stage 80-1 of FIG. 5), and other shift multiplexers may be truncated to have unequal-sized first/second portions (e.g. a truncated shift multiplexer 82-3′ in stage 80-3 of FIG. 9 processes a group of elements R″[0] to R″[4] such that the first portion comprises a single element R″[4] and the second portion comprises four elements R″[0] to R″[3], with the shift multiplexing logic for that truncated multiplexer 82-3′ being modified compared to the symmetric complete example of FIG. 5 by removing outputs for non-existent column positions 5-7 and injecting the value of the upper remaining element R″[4] or a placeholder value P in the positions which are shifted in based on element positions beyond position [4] (see the cells in the table below shown in italics, which differ from the corresponding values in the example logic given above for shift multiplexer 82-3 in a case where k=0), as there are not enough upper elements to provide values for R″[k+5] to R″[k+7] that were shown in the earlier example of the shift multiplexer 82-3 logic.

### Truncated Shift Multiplexer 82-3′ Logic

| U[0-3] | R″′[4] | R″′[3] | R″′[2] | R″′[1] | R″′[0] |
|---|---|---|---|---|---|
| 4 | R″[k + 4] | R″[k + 4] | R″[k + 4] | R″[k + 4] | R″[k + 4] |
| | or P | or P | or P | or P | |
| 3 | R″[k + 4] | R″[k + 4] | R″[k + 4] | R″[k + 4] | R″[k] |
| | or P | or P | or P | | |
| 2 | R″[k + 4] | R″[k + 4] | R″[k + 4] | R″[k + 1] | R″[k] |
| | or P | or P | | | |
| 1 | R″[k + 4] | R″[k + 4] | R″[k + 2] | R″[k + 1] | R″[k] |
| | or P | | | | |
| 0 | R″[4] | R″[3] | R″[2] | R″[1] | R″[0] |

For the bit injections, the asymmetry in the binary tree occurring when there are discontinuities in register identifier space may mean that the alternating patterns of 0s and 1s injected at a given stage no longer forms a balanced pattern, since the values of the bits injected at each stage still correspond to the next most significant bit of the corresponding identifier value in each column position. For example, as shown in FIG. 9, at bit injection stage 84-2 the alternating pattern (from element position 0 to element position 14) becomes 0, 0, 0, 0, 1 [gap], 0, 0, 0, 0, 1, 1, 1, removing some of the 1s that would otherwise have been injected in the column positions [5-7] at positions corresponding to the marker [gap] in the above sequence.

Other than omitting some portions of the shift tree or truncating some shifters or bit injection logic, the asymmetric tree can function in a similar way to the examples discussed above. Similarly, the adder tree in the unavailable resource counting circuitry 54 can prune any adder nodes which are not needed because the corresponding parts of the shift circuitry 56 are not present. It will be appreciated that the particular shift/adder tree nodes which are pruned from the tree, or which have some truncated shifters, may depend on the particular distribution of valid resource identifiers within the resource identifier space.

It will also be appreciated that the particular number of resources in the set can be varied, so the number of stages of addition and shifts in the binary trees described above can be extended to handle the required number of resources and maximum number of resources selectable. Similarly, the maximum number of resources selectable in one cycle could be a value other than N=6, which may influence the number of element positions which can start to be dropped from being calculated in later stages of the tree.

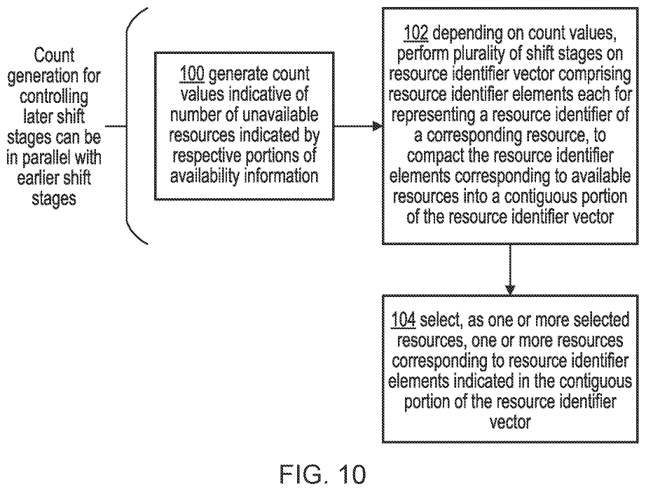

FIG. 10 is a flow diagram showing steps of resource selection performed by the resource selection circuitry 50 in hardware circuit logic within a processor 2. At step 100, the unavailable resource counting circuitry 54 generates a number of count values U, each indicating a number of unavailable resources indicated by respective (partially overlapping) portions of availability information 52. At step 102, the shift circuitry 56 performs, depending on the count values U generated by the unavailable resource counting circuitry 54, a number of shift stages 80 on a resource identifier vector 56 comprising resource identifier elements each for representing a resource identifier of a corresponding resource, to compact the resource identifier elements corresponding to available resources into a contiguous portion of the resource identifier vector by the end of the final shift stage. The unavailable resource counting circuitry 54 and shift circuitry 56 may operate partially in parallel, so that count generation by later adder stages 72 of the unavailable resource counting circuitry 54 for step 100 can operate in parallel with earlier shift stages 80 of the shift circuitry 56 for step 102 (those earlier shift stages 80 depending on the count values generated by earlier adder stages 72 than the adder stages 72 which operate in parallel with those earlier shift stages 80). By partially parallelizing later addition stages with earlier shift stages, this can improve performance and reduce critical path timing through the resource selection circuitry 50. At step 104, the selection circuitry 60 selects, as the one or more selected resources, one or more resources corresponding to the resource identifier elements indicated in the contiguous portion of the resource identifier vector.

Concepts described herein may be embodied in a system comprising at least one packaged chip. The processor and/or the resource selection circuitry described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

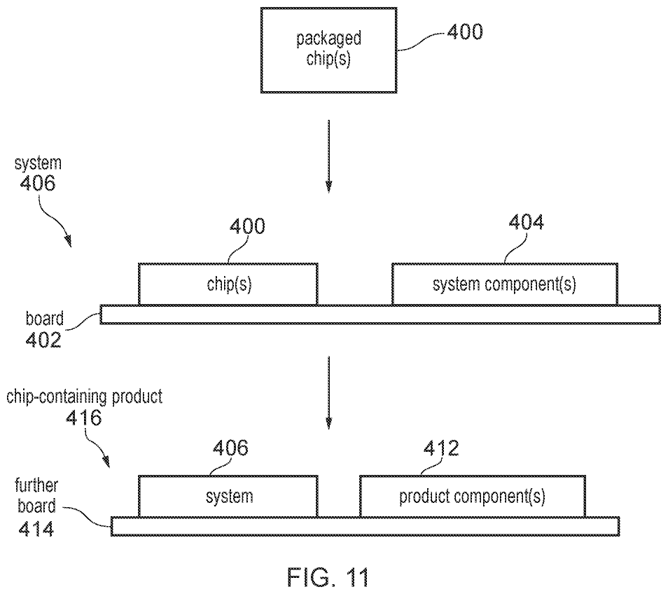

As shown in FIG. 11, one or more packaged chips 400, with the processor and/or the resource selection circuitry described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the processor and/or the resource selection circuitry described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some examples are set out in the following clauses:
1. Resource selection circuitry to select one or more selected resources from among a set of resources, based on availability information indicating whether each resource is available or unavailable for selection; the resource selection circuitry comprising:
   unavailable resource counting circuitry to generate count values indicative of a number of unavailable resources indicated by respective portions of the availability information;
   shift circuitry to perform, depending on the count values, a plurality of shift stages on a resource identifier vector comprising a plurality of resource identifier elements each for representing a resource identifier of a corresponding one of the resources, to compact the resource identifier elements corresponding to available resources into a contiguous portion of the resource identifier vector; and
   selection circuitry to select, as the one or more selected resources, one or more resources corresponding to resource identifier elements indicated in said contiguous portion of the resource identifier vector.
2. The resource selection circuitry according to clause 1, in which the shift circuitry comprises a binary tree of shifters.
3. The resource selection circuitry according to any of clauses 1 and 2, in which, for a given shift stage applied to one or more groups of resource identifier elements from the resource identifier vector, for each group the shift circuitry is configured to shift resource identifier elements of a first portion of the group by a given number of element positions into a second portion of the given group, said given number corresponding to the number of unavailable resources indicated by a given count value generated by the unavailable resource counting circuitry based on a portion of the availability information corresponding to the second portion of the given group.
4. The resource selection circuitry according to clause 3, in which the second portion of the given group comprises a number of resource identifier elements which is an exact power of 2.
5. The resource selection circuitry according to any of clauses 3 and 4, in which a number of resource identifier elements in the second portion of each group increases from one shift stage to the next shift stage.
6. The resource selection circuitry according to any of clauses 3 to 5, in which for at least one of the shift stages, the shift circuitry is configured to:
   apply a first shift to the first portion of the group, based on a first term of a redundant representation of the given count value; and
   apply a second shift to a result of applying the first shift to the first portion of the group, based on a second term of the redundant representation of the given count value.
7. The resource selection circuitry according to any of clauses 1 to 6, comprising bit injection circuitry to inject, following a given shift stage other than a final shift stage, an additional identifier bit into respective resource identifier elements of the resource identifier vector.
8. The resource selection circuitry according to clause 7, in which the bit injection circuitry is configured to inject the additional identifier bit for a given resource identifier element at a most significant bit position of the given resource identifier element.
9. The resource selection circuitry according to any of clauses 7 and 8, in which:
   the plurality of shift stages comprise X shift stages;
   the set of resources comprises Y resources each identified by an X-bit resource identifier; and
   for a resource identifier element at a j^{th} element position within a shifted resource identifier vector output by an i^{th} shift stage, where 1≤i≤X−1 and 0≤j≤Y−1, the additional identifier bit injected for that resource identifier element has the same value as bit [i] of a resource identifier ID[X-1:0] which is equal to j.
10. The resource selection circuitry according to any of clauses 1 to 9, in which the unavailable resource counting circuitry comprises adding circuitry to add a plurality of elements of availability information corresponding to a given portion of the availability information, to generate the count value for the given portion.
11. The resource selection circuitry according to any of clauses 1 to 10, in which the unavailability resource counting circuitry comprises a binary tree of adders.
12. The resource selection circuitry according to any of clauses 1 to 11, in which the contiguous portion of the resource identifier vector comprises a most significant portion of the resource identifier vector or a least significant portion of the resource identifier vector.
13. The resource selection circuitry according to any of clauses 1 to 12, in which the set of resources comprises a set of processor resources for use by a processor.
14. The resource selection circuitry according to any of clauses 1 to 13, in which the set of resources comprises a set of physical registers and the availability information indicates whether each physical register is available for being mapped to an architectural register by register renaming circuitry.
15. The resource selection circuitry according to any of clauses 1 to 14, in which the set of resources comprises a set of cache entries and the availability information indicates whether each cache entry is available for being allocated with cached information.
16. A processor comprising the resource selection circuitry according to any of clauses 1 to 15.
17. A system comprising:
   the resource selection circuitry according to any of clauses 1 to 15 or the processor according to clause 16, implemented in at least one packaged chip;
   at least one system component; and
   a board,
   wherein the at least one packaged chip and the at least one system component are assembled on the board.
18. A chip-containing product comprising the system of clause 17 assembled on a further board with at least one other product component.
19. A non-transitory computer-readable medium to store computer-readable code for fabrication of resource selection circuitry to select one or more selected resources from among a set of resources, based on availability information indicating whether each resource is available or unavailable for selection; the resource selection circuitry comprising:
   unavailable resource counting circuitry to generate count values indicative of a number of unavailable resources indicated by respective portions of the availability information;
   shift circuitry to perform, depending on the count values, a plurality of shift stages on a resource identifier vector comprising a plurality of resource identifier elements each for representing a resource identifier of a corresponding one of the resources, to compact the resource identifier elements corresponding to available resources into a contiguous portion of the resource identifier vector; and
   selection circuitry to select, as the one or more selected resources, one or more resources corresponding to resource identifier elements indicated in said contiguous portion of the resource identifier vector.
20. A method for selecting one or more selected resources from among a set of resources, based on availability information indicating whether each resource is available or unavailable for selection; the method comprising:
   using unavailable resource counting circuitry, generating count values indicative of a number of unavailable resources indicated by respective portions of the availability information;
   using shift circuitry, performing, depending on the count values, a plurality of shift stages on a resource identifier vector comprising a plurality of resource identifier elements each for representing a resource identifier of a corresponding one of the resources, to compact the resource identifier elements corresponding to available resources into a contiguous portion of the resource identifier vector; and
   using selection circuitry, selecting, as the one or more selected resources, one or more resources corresponding to resource identifier elements indicated in said contiguous portion of the resource identifier vector.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. Resource selection circuitry to select one or more selected resources from among a set of resources, based on availability information indicating whether each resource is available or unavailable for selection; the resource selection circuitry comprising:
unavailable resource counting circuitry to generate count values indicative of a number of unavailable resources indicated by respective portions of the availability information;
shift circuitry to perform, depending on the count values, a plurality of shift stages on a resource identifier vector comprising a plurality of resource identifier elements each for representing a resource identifier of a corresponding one of the resources, to compact the resource identifier elements corresponding to available resources into a contiguous portion of the resource identifier vector; and
selection circuitry to select, as the one or more selected resources, one or more resources corresponding to resource identifier elements indicated in said contiguous portion of the resource identifier vector.

2. The resource selection circuitry according to claim 1, in which the shift circuitry comprises a binary tree of shifters.

3. The resource selection circuitry according to claim 1, in which, for a given shift stage applied to one or more groups of resource identifier elements from the resource identifier vector, for each group the shift circuitry is configured to shift resource identifier elements of a first portion of the group by a given number of element positions into a second portion of the given group, said given number corresponding to the number of unavailable resources indicated by a given count value generated by the unavailable resource counting circuitry based on a portion of the availability information corresponding to the second portion of the given group.

4. The resource selection circuitry according to claim 3, in which the second portion of the given group comprises a number of resource identifier elements which is an exact power of 2.

5. The resource selection circuitry according to claim 3, in which a number of resource identifier elements in the second portion of each group increases from one shift stage to the next shift stage.

6. The resource selection circuitry according to claim 3, in which for at least one of the shift stages, the shift circuitry is configured to:
apply a first shift to the first portion of the group, based on a first term of a redundant representation of the given count value; and
apply a second shift to a result of applying the first shift to the first portion of the group, based on a second term of the redundant representation of the given count value.

7. The resource selection circuitry according to claim 1, comprising bit injection circuitry to inject, following a given shift stage other than a final shift stage, an additional identifier bit into respective resource identifier elements of the resource identifier vector.

8. The resource selection circuitry according to claim 7, in which the bit injection circuitry is configured to inject the additional identifier bit for a given resource identifier element at a most significant bit position of the given resource identifier element.

9. The resource selection circuitry according to claim 7, in which:
the plurality of shift stages comprise X shift stages;
the set of resources comprises Y resources each identified by an X-bit resource identifier; and
for a resource identifier element at a j^{th} element position within a shifted resource identifier vector output by an i^{th} shift stage, where 1≤i≤X−1 and 0≤j≤Y−1, the additional identifier bit injected for that resource identifier element has the same value as bit [i] of a resource identifier ID[X-1:0] which is equal to j.

10. The resource selection circuitry according to claim 1, in which the unavailable resource counting circuitry comprises adding circuitry to add a plurality of elements of availability information corresponding to a given portion of the availability information, to generate the count value for the given portion.

11. The resource selection circuitry according to claim 1, in which the unavailability resource counting circuitry comprises a binary tree of adders.

12. The resource selection circuitry according to claim 1, in which the contiguous portion of the resource identifier vector comprises a most significant portion of the resource identifier vector or a least significant portion of the resource identifier vector.

13. The resource selection circuitry according to claim 1, in which the set of resources comprises a set of processor resources for use by a processor.

14. The resource selection circuitry according to claim 1, in which the set of resources comprises a set of physical registers and the availability information indicates whether each physical register is available for being mapped to an architectural register by register renaming circuitry.

15. The resource selection circuitry according to claim 1, in which the set of resources comprises a set of cache entries and the availability information indicates whether each cache entry is available for being allocated with cached information.

16. A processor comprising the resource selection circuitry according to claim 1.

17. A system comprising:
the resource selection circuitry according to claim 1, implemented in at least one packaged chip;
at least one system component; and
a board,
wherein the at least one packaged chip and the at least one system component are assembled on the board.

18. A chip-containing product comprising the system of claim 17 assembled on a further board with at least one other product component.

19. A non-transitory computer-readable medium to store computer-readable code for fabrication of resource selection circuitry to select one or more selected resources from among a set of resources, based on availability information indicating whether each resource is available or unavailable for selection; the resource selection circuitry comprising:
unavailable resource counting circuitry to generate count values indicative of a number of unavailable resources indicated by respective portions of the availability information;
shift circuitry to perform, depending on the count values, a plurality of shift stages on a resource identifier vector comprising a plurality of resource identifier elements each for representing a resource identifier of a corresponding one of the resources, to compact the resource identifier elements corresponding to available resources into a contiguous portion of the resource identifier vector; and
selection circuitry to select, as the one or more selected resources, one or more resources corresponding to resource identifier elements indicated in said contiguous portion of the resource identifier vector.

20. A method for selecting one or more selected resources from among a set of resources, based on availability information indicating whether each resource is available or unavailable for selection; the method comprising:
using unavailable resource counting circuitry, generating count values indicative of a number of unavailable resources indicated by respective portions of the availability information;
using shift circuitry, performing, depending on the count values, a plurality of shift stages on a resource identifier vector comprising a plurality of resource identifier elements each for representing a resource identifier of a corresponding one of the resources, to compact the resource identifier elements corresponding to available resources into a contiguous portion of the resource identifier vector; and
using selection circuitry, selecting, as the one or more selected resources, one or more resources corresponding to resource identifier elements indicated in said contiguous portion of the resource identifier vector.
